(19) United States
(12) Patent Application Publication
(10) Pub. No.: US 2019/0266242 A1
(43) Pub. Date: Aug. 29, 2019

(54) METHOD AND APPARATUS TO CLASSIFY AND MITIGATE CYBERBULLYING

(71) Applicant: Advait Arumugam, Irvine, CA (US)

(72) Inventor: Advait Arumugam, Irvine, CA (US)

(21) Appl. No.: 16/286,960

(22) Filed: Feb. 27, 2019

Related U.S. Application Data
(60) Provisional application No. 62/635,560, filed on Feb. 27, 2018.

(51) Int. Cl. G06F 17/27; G06N 20/00

(52) U.S. Cl. CPC G06F 17/2785; G06N 20/10; G06N 20/00

(57) ABSTRACT

Cyberbullying may be mitigated by intercepting and accurately analyzing the sentiment of the social media messages before presenting them to the intended recipient device. Based on the sentiment of the messages and the sender category, the abusive messages may be sent to an administrator for review and to take appropriate action. As a result, such messages may be blocked from the intended recipient device. The system may analyse the sentiment of the messages using a machine learning approach, for instance employing a Naive Bayes algorithm. An inference model may be generated via the machine learning. The inference model may produce a metric that is used when evaluating the message sentiment.

### CROSS-REFERENCE TO RELATED APPLICATIONS

This application claims the benefit of the filing date of U.S. Provisional Application No. 62/635,560, filed Feb. 27, 2018 and entitled “METHOD AND APPARATUS TO CLASSIFY AND MITIGATE CYBERBULLYING,” the entire disclosure of which is hereby expressly incorporated by reference herein.

### BACKGROUND

The present disclosure relates generally to methods and apparatus for mitigation of cyberbullying using machine learning techniques.

Cyberbullying is the use of technology to harass, threaten, embarrass, or unfairly target another person. Typically, it occurs among young people. Severe, long-term, or frequent cyberbullying can leave both victims and bullies at greater risk of stress-related disorders. In some rare but highly publicized cases, some young people have turned to suicide. Experts say that young people who are bullied—and the bullies themselves—are at a higher risk for suicidal thoughts, attempts, and completed suicides. Additionally, cyberbullying also occurs in the adult population, especially towards minorities or marginalized communities. The impacts of this virtual harassment can be as catastrophic as with those of younger demographics.

### SUMMARY

Cyberbullying may be mitigated by intercepting and accurately analyzing the sentiment of the social media messages before presenting it to the recipient. Based on the sentiment of the messages and the sender category, the abusive messages may be sent to an Administrator for review and to take appropriate action

Machine Learning (ML), a sub-field of Artificial Intelligence (AI), is the ability to automatically learn and improve from experience (prior observations) without being explicitly programmed to do so. ML may use a significant amount of training data to find patterns and use that to make inferences for new data. ML algorithms may be used for automatic classification and detection of cyberbullying.

Available ML algorithms include, but are not limited to, the following: Naïve Bayes, Nearest Neighbor Estimator, Support Vector Machine (SVM), and Decision Tree.

Naive Bayes is a probabilistic supervised learning method that calculates the probability of a data item belonging to a certain class.

Nearest Neighbor Estimator is one of the simpler estimators that uses distance between data instances to map a certain instance to its closest distance neighbor.

Support Vector Machine is a supervised learning method and a binary classifier. It assumes a clear distinction between data samples. It tries to find an optimal hyper-plane that maximizes the margin between classes.

Decision Tree is a supervised learning method and classifies data using a command and conquer approach. An example implementation is the C4.5 algorithm.

Naive Bayes classifiers are mostly used in text classification (due to better result in multi class problems and independence rule) and may have higher success rate as compared to other algorithms. As a result, this technique is widely used in Spam Filtering (identifying and blocking spam e-mail) and Sentiment Analysis (in social media analysis, to identify positive and negative sentiments). Naive Bayes classifiers may be extended for cyberbullying classification and detection according to aspects of the technology.

Naive Bayes is a classification technique based on Bayes' Theorem with an assumption of independence among predictors. In simple terms, a Naive Bayes classifier assumes that the presence of a particular feature in a class is unrelated to the presence of any other feature. A Naive Bayes model relatively easy to build and particularly useful for very large data sets. Along with simplicity, the Naive Bayes approach is known to outperform even highly sophisticated classification methods.

Bayes theorem provides a way of calculating posterior probability P(A|B), i.e., the probability of event A occurring given that event B has occurred from P(A), P(B) and P(B|A):

$$P ( A \vert B ) = \frac{P ( B \vert A ) * P ( A )}{P ( B )}$$

Where:
P(A|B) is the posterior probability of class (A, target) given predictor (B, attributes).
P(A) is the prior probability of class A.
P(B|A) is the likelihood which is the probability of predictor given class.
P(B) is the prior probability of predictor.

There are pros and cons of the Naive Bayes approach.

Pros:
Easy and fast in predicting class of test data set and performs well in multi-class prediction.
When assumption of independence holds, it performs better compared to other models like logistic regression with less training data.

Cons:
If a categorical variable has a category, which was not observed in training data set, then the model will assign a zero probability and will be unable to make a prediction. This is often known as “Zero Frequency.” To solve this, smoothing techniques may be used.
Another limitation is the assumption of independent predictors. In real life, it is almost impossible to get a set of predictors which are completely independent.

Cyberbullying is a major issue in today's world, especially among youth who are experiencing the freedom of the internet and social media. The methods and apparatuses that are disclosed herein may enable automatic identification and mitigation of cyberbullying utilizing machine learning techniques. The methods disclosed herein may be implemented as a computer program which may run on a variety of processing devices such as a smartphone, a mobile phone, a personal computer, a tablet, a gaming console, or any other device with internet and social media connectivity. The methods disclosed herein may also be implemented in hardware processing circuits which may be general purpose or customized such as in Application Specific Integrated Circuits (ASIC), Field Programmable Gate Arrays (FPGA), microcontrollers, microprocessors, or a Digital Signal Processors (DSP). An example ASIC may include the Tensor Processing Unit (TPU). Another example may be Graphics Processing Unit (GPU) of a personal computer. Yet another example may be a specialized ML hardware inside the Application Processor (AP) of a smartphone. The method and apparatus disclosed herein are collectively referred herein as CYBIAN regardless of the particular implementation types mentioned above. The terms CYBIAN, CYBIAN system, and CYBIAN method are used interchangeably herein.

CYBIAN may operate in any device used for receiving messages over the internet or social media before presenting it to the user. According to one aspect of the technology, CYBIAN may intercept all messages sent over social media to a particular recipient device, may categorize the message based on the sender identity, and may use one or more ML algorithms to classify the message as abusive or not abusive from a certain category of known contacts as well as unknown contacts. If a message is not abusive, CYBIAN may allow the message to reach the recipient device transparently. If a message is found abusive, it may not be sent to the intended recipient but instead sent for review and approval to the CYBIAN account of the registered Administrator who may be a parent/guardian or a mentor of the recipient. The message may eventually be sent to the original intended recipient device if the Administrator approves it. A message not approved by the Administrator may be discarded and/or the Administrator may take necessary action. CYBIAN may use ML algorithms with large datasets as a training dataset to classify messages to determine whether the message is abusive or not abusive. In this manner CYBIAN may effectively reduce or minimize cyberbullying.

### BRIEF DESCRIPTION OF THE DRAWINGS

FIG. 1 illustrates an example use case of the CYBIAN system in action for mitigating cyberbullying according to aspects of the present disclosure.

FIG. 2 illustrates an example flow diagram for implementation of the CYBIAN system at an intended recipient device according to aspects of the present disclosure.

FIG. 3 illustrates an example flow diagram for implementation of the CYBIAN system at an Administrator device according to aspects of the present disclosure.

FIG. 4 illustrates an example of Open Systems Interconnection (OSI) model for hierarchical software structure that may be used for implementation of the CYBIAN system at intended recipient and Administrator devices according to aspects of the present disclosure.

FIG. 5 illustrates an example block diagram for implementation of the ML methods may be used by CYBIAN system according to aspects of the present disclosure.

FIG. 6 illustrates various subsystems of a smartphone, which may be employed with aspects of disclosure described herein.

FIG. 7 illustrates an application processor subsystem for a smartphone, which may be employed with aspects of the disclosure described herein.

### DETAILED DESCRIPTION

The foregoing aspects, features, and advantages of the present disclosure will be further appreciated when considered with reference to the following description of exemplary embodiments and accompanying drawings, wherein like reference numerals represent like elements. In describing the exemplary embodiments of the present disclosure illustrated in the appended drawings, specific terminology will be used for the sake of clarity. However, the present disclosure is not intended to be limited to the specific terms used.

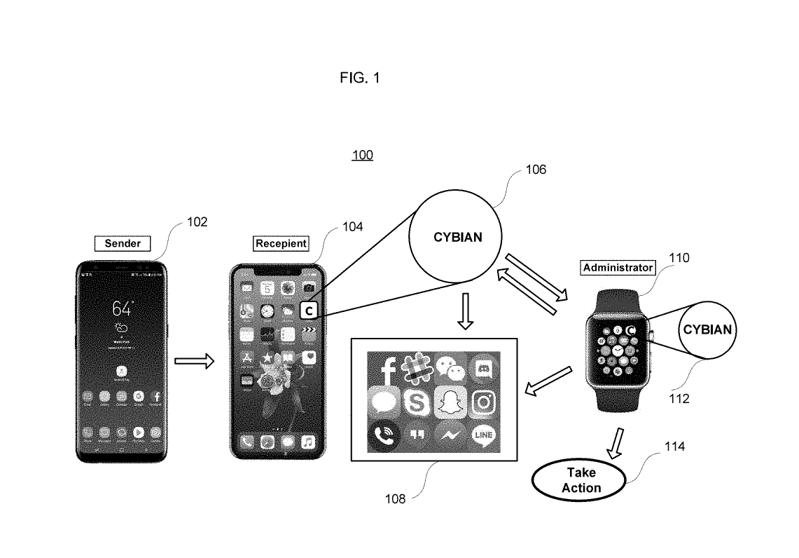

FIG. 1 illustrates an example use case of the CYBIAN system 100 in action for mitigating cyberbullying according to aspects of the present disclosure. Specifically, a user of the sender device 102 may send a social media message to the intended recipient device 104. According to an aspect of the present disclosure, a CYBIAN method 106 for countering cyberbullying may be operating in the intended recipient's device. According to an aspect of the present disclosure, if the CYBIAN method 106 determines that the received message is not abusive, then it may send the message to the relevant social media application 108 running on the intended recipient device 104. According to an aspect of the present disclosure, if the CYBIAN method 106 determines that the received message is potentially abusive, it may send the message to the CYBIAN method 112 on the Administrator device 110 for review and to take appropriate action per block 114. If the Administrator (e.g., human user of the device 110) determines that the received message is not abusive, then the Administrator may provide that indication to the CYBIAN method 112 operating in the Administrator device 110. According to an aspect of the present disclosure, the Administrator device 110 may then communicate with the CYBIAN method 106 operating in the intended recipient device 104. According to another aspect of the present disclosure, based on the indication from the CYBIAN method 112 that the message is non-abusive, the CYBIAN method 106 may present the message to the relevant social media application running on the recipient device 104.

If the Administrator (e.g., human user of the device 110) determines that the received message is abusive, then the Administrator may provide that indication to the CYBIAN method 112 operating in the device 110. Appropriate action may be taken per block 114. For instance, the CYBIAN method 112 may communicate with the CYBIAN method 106 operating in the intended recipient device 104. According to an aspect of the present disclosure, based on the indication from the CYBIAN method 112 that the message is abusive, the CYBIAN method 106 may not present the message to the relevant social media application running on the recipient device 104. Returning to the Administrator (e.g., human user of the device 110), when a message is determined to be abusive by the Administrator, he or she may log the message locally in the device 110. The logging may include all the relevant information of the message, such as the sender identity, time of the day, social media application on which the message was sent, the text and audiovisual content of the message, any other available meta-information such as other recipients of the same message (in a group message situation), the Transmission Control Protocol (TCP)/Internet Protocol (IP) or Media Access Control (MAC) address of the sending device, etc.

According to another aspect of the present disclosure, the Administrator may log the message in a cloud storage system (not shown in the figure), which may include all the relevant information of the message such as the sender identity, time of the day, social media application on which the message was sent, the text and/or audio visual content of the message, any other available meta-information such as other recipients of the same message (in a group message situation), the Transmission Control Protocol (TCP)/Internet Protocol (IP) or Media Access Control (MAC) address of the sending device, etc. According to a further aspect of the present disclosure, the CYBIAN method 112 may help extract and save such information about the messages identified by the human user of the device 110. The illustration in FIG. 1 shows the CYBIAN system with a single Administrator. However, according to an aspect of the present disclosure, the CYBIAN system may also work with multiple Administrators. Each Administrator may possibly having different privileges, for instance with regard to how abusive messages are treated. The terms social media message and message are used interchangeably herein. According to an aspect of the present disclosure, the CYBIAN system may use a similar method to monitor and detect abusive messages originating from the sender's device. This aspect may help mitigate bullying from the originating source as opposed or in addition to the receiving end.

According to an aspect of the present disclosure, the CYBIAN method 106 may use the sender identity and all its contents as inputs for its processing. In one scenario, the CYBIAN method 106 may first classify the sender identities into two or more categories. For instance, category 1 (CAT_1) may include all trusted senders, such as family members and other close friend and relatives. Category 2 (CAT_2) may include senders such as known friends and colleagues from school. And category 3 (CAT_3) may include unknown senders and/or known senders who may have a history of sending abusive messages to the intended or other recipients. The number of categories used may be configurable along with the definition of requirements belonging to each category. According to an aspect of the present disclosure, when a new contact is added to the device with the CYBIAN method, the contact may be assigned to a particular category. According to another aspect of the present disclosure, the category of the contact may be changed at any point of time.

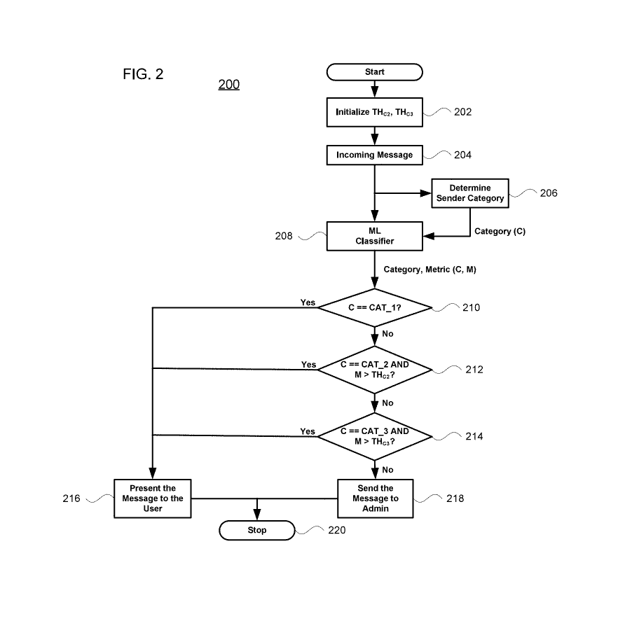

The flow diagram 200 contained in FIG. 2 illustrates processing steps performed inside an example of the CYBIAN method 106 in the recipient's device for mitigating cyberbullying according to aspects of the present disclosure. In this example, the processing begins at processing stage 202 where the parameters of the CYBIAN system are initialized. This can include initializing one or more threshold values used to help determine whether a message is non-abusive, somewhat abusive, very abusive, etc. These threshold values may be on a scale of 0 to 100, with 0 representing a very abusive message and 100 representing a non-abusive (e.g., truly safe) message. For example, the values of thresholds TH_{C2} and TH_{C3} (see blocks 212 and 214 in FIG. 2) may be initialized to 20 and 60, respectively. The threshold(s) may be custom based on the number of categories as well as the restrictions on the different categories. The threshold(s) may also be varied depending on which machine learning algorithm is employed in the overall training process.

In another example, the number of categories of senders and the definition of requirements of those categories may be initialized at this step. At processing stage 204, a message from a sender is intercepted (or otherwise received) by the CYBIAN method 106. At processing stage 206, a determination is made about the category of the sender. At processing stage 208, the category (C) is received from processing stage 206 and the input message is received from processing stage 204. A Machine Learning (ML) classifier in processing stage 208 may perform the classification of the input message based on the inference model derived from the training dataset. For example, the ML classifier may use Naive Bayes algorithm, Support Vector Machine (SVM), Decision Tree, or any other custom algorithm.

The ML classifier at processing stage 208 outputs the category C and a metric M. The metric M may have a normalized range of 0-100, where 0 may correspond to a for-sure abusive message and 100 may correspond to a for-sure non-abusive message. At processing stage 210, if the category C is equal to CAT_1, the message is considered to be from a trusted source and it is sent to processing stage 216 so that the message may be presented to the intended recipient. At processing stage 210, if the category C is not equal to CAT_1, the processing advances to stage 212. At processing stage 212, if the category C is equal to CAT_2 and the metric M is greater than the configured threshold TH_{C2}, the message is considered to be non-abusive and it is sent to processing stage 216. At processing stage 212, if the category C is not equal to CAT_2 or the metric M is less than or equal to the configured threshold TH_{C2}, the processing advances to stage 214. At processing stage 214, if the category C is equal to CAT_3 and the metric M is greater than the configured threshold TH_{C3}, the message is considered to be non-abusive and it is sent to processing stage 216. Otherwise, at processing stage 214, if the category C is not equal to CAT_3 or the metric M is less than or equal to the configured threshold TH_{C3}, the processing advances to stage 218. At processing stage 218, the message is sent to the CYBIAN method 112 in the Administrator device 110 for further consideration by the Administrator. According to an aspect of the present disclosure, the incoming message at the Administrator device 110 may include sender category C, ML classifier metric M, and the actual message contents along with all other meta-information. After either stage 216 or 218, the processing suitably terminates at stage 220. While three category levels are shown, more (or fewer) levels may be employed.

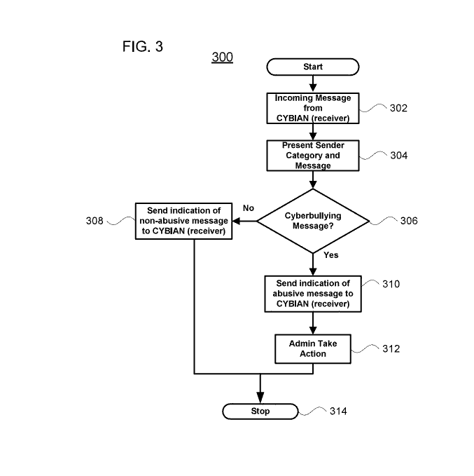

The flow diagram 300 contained in FIG. 3 illustrates processing steps performed inside an example of the CYBIAN method 112 at the Administrator device 110 for mitigating cyberbullying according to the aspects of the present disclosure. According to an aspect of the present disclosure, the processing begins at processing stage 302 where a message is received from the CYBIAN method 106 operating in the intended recipient device 104. According to an aspect of the present disclosure, the incoming message may include sender category C, ML classifier metric M, and the actual message contents along with all other meta-information. At processing stage 304, the incoming message is presented to the Administrator over the user interface of the Administrator device 110. At processing stage 306, the Administrator judges whether the message is abusive or not. The Administrator may give that indication of his/her judgment via the user interface to the CYBIAN method 112. If the Administrator judgment from user interface indicates that the message is non-abusive, the processing advances to stage 308. At processing stage 308, indication of non-abusive message may be sent to the CYBIAN system 106 operating in the intended recipient device 104. Otherwise, if the Administrator judgment from user interface indicates that the message is abusive, the processing advances to stage 310. At processing stage 310, indication of abusive message is sent to the CYBIAN system 106 operating in the intended recipient device 104. At processing stage 312, the Administrator may take action to mitigate the abusive message and the cyberbullying. Some examples of the types of action include 1) an administrator confronting the bully either in real life or digitally, 2) blocking the bully's abusive content, 3) an administrator escalating the issue to school authorities, or, in certain cases, the local police or government, 4) an administrator addressing the issue with the victim, 5) an administrator helping the victim overcome the bullying, and/or 6) an administrator addressing the issue with the parents/guardians of the abuser and/or the victim. The processing suitably terminates at stage 314.

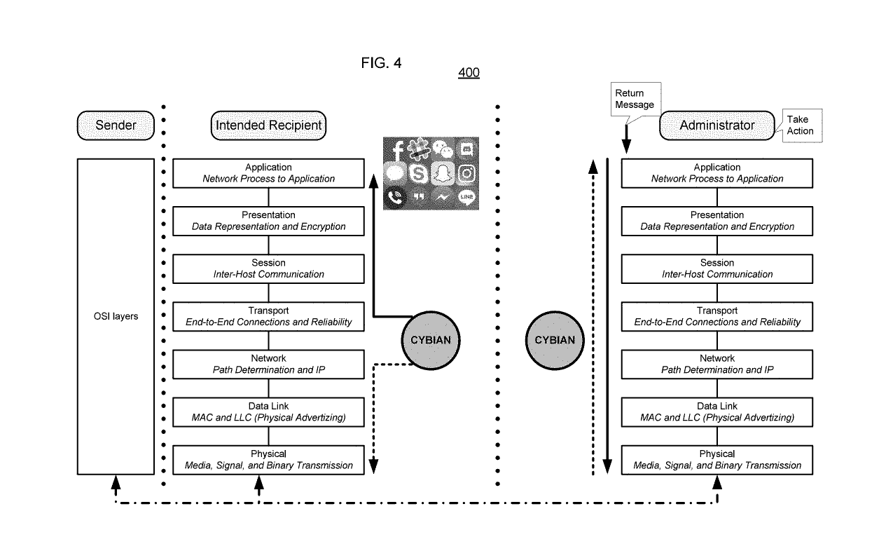

The above processes may be implemented in accordance with the Open Systems Interconnection model (OSI model). The OSI model is a conceptual model that characterizes and standardizes the communication functions of a telecommunication or computing system without regard to its underlying internal structure and technology. Its goal is the interoperability of diverse communication systems with standard protocols. The model partitions a communication system into abstraction layers. Modern communication systems in devices such as smartphones, personal computers, etc. use the OSI model. FIG. 4 illustrates key OSI model layers in the sender, intended recipient, and Administrator devices. The social media and other applications generally operate at the Application layer at the top of the hierarchy. This layer interfaces with the user via the display and audio interfaces. The routing functions in the OSI model are generally handled at the Transport layer and Network layer.

The most commonly used protocol at these two layers are User Datagram Protocol (UDP)/Transmission Control Protocol (TCP) and Internet Protocol (IP) respectively. Most communications involve some sort of identity (ID) for the transmitting and receiving entities. These identities are commonly referred to as TCP/IP address. There may be other higher layer identities used by a system. For example, a user may have a Facebook ID, Twitter ID, etc. According to an aspect of the present disclosure, the CYBIAN method may operate at any one or more of the OSI layers and may use any or all available IDs to perform its function to identify a unique sender which may be categorized into one of the categories described above. According to an aspect of the present disclosure, the CYBIAN method may use the access credentials of the intended recipient for any or all of his/her social media applications. For instance, the CYBIAN method may use these access credentials to intercept the social media messages and process them for presence of abusive content. This may enable the CYBIAN method to operate even when the social media messages are encrypted.

FIG. 4 illustrates the integration of the CYBIAN method at many OSI layers at both the intended recipient device and the Administrator side. According to an aspect of the present disclosure, the CYBIAN system may be integrated in one or more layers as shown in FIG. 4 at both the intended recipient device and the Administrator side. According to another aspect of the present disclosure, the CYBIAN system may be integrated into one or more of the applications for peer to peer communications. For example, the CYBIAN system may be integrated into applications such as Instagram, Facebook, or Twitter at both the intended recipient device and the Administrator side. In another aspect of the present disclosure, the CYBIAN system may be integrated in one or more of the layers in the recipient device and on the application of the Administrative device or vice versa.

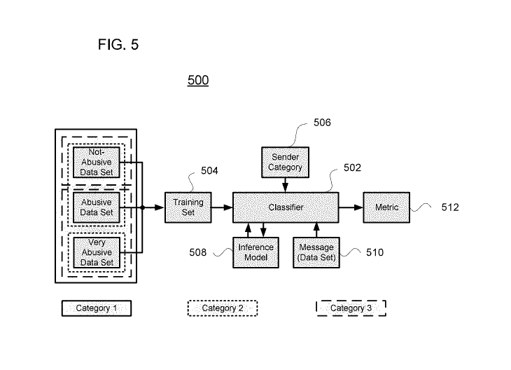

The block diagram 500 in FIG. 5 shows details of the ML classifier 208 of FIG. 2 used in the CYBIAN method. As shown in the figure, the ML classifier includes the classifier 502 which may include, for example, Naive Bayes algorithm. The classifier 502 is input with training dataset 504 which may comprise, e.g., three different types of datasets of messages: a non-abusive message dataset, an abusive messages dataset, and a very abusive messages dataset. Further, based on the sender ID, the three datasets may be grouped into category 1 (CAT_1), category 2 (CAT_2) and category 3 (CAT_3) datasets. This grouping is illustrated by different line styles of the outer boxes surrounding the individual datasets, such as dotted lines, dashed lines or solid lines.

The training dataset 504 may be used to train the ML algorithm but may not be implemented into the CYBIAN system in the end user devices. The training of ML algorithm may be performed by developers and not be by the users. The classifier 502 also uses the sender category 506 information as an input. After running the ML algorithm on this training dataset, for example, using Naive Bayes algorithm, it may obtain a model referred herein as the inference model, which may reflect the various patterns in the dataset discovered by the classifier. After having finished training, the classifier may save the inference model 508. The CYBIAN system developers may continue to improve the ML algorithm with additional training with additional datasets. This in turn may lead to an improved inference model. The CYBIAN developers may periodically update the inference model within the users' devices over the internet. According to an aspect of the present disclosure, the training dataset may be located in cloud storage and the CYBIAN system may access the training dataset on need basis. When a new message (data set) 510 is received from a sender from a particular category, the classifier may use the previously saved inference model 508 to compute a metric 512 which is output to other subsystems for further processing as shown in FIG. 3.

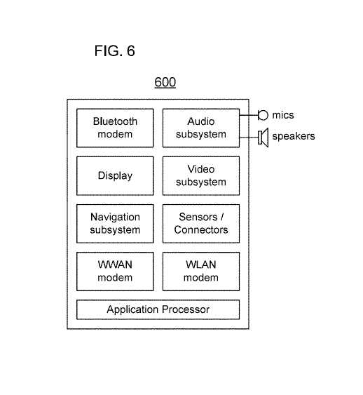

In one of the embodiments, the CYBIAN method may be implemented in the intended recipient's smartphone. As shown in FIG. 6 the smartphone may include a built-in Wireless Wide Area Network (WWAN) modem, a Wireless Local Area Network (WLAN) modem, and/or a Bluetooth® modem. The smartphone may also include an audio subsystem, video subsystem, a display, a navigation system, and various sensors and connectors. All the subsystems of the smartphone may be controlled by the Application Processor (AP).

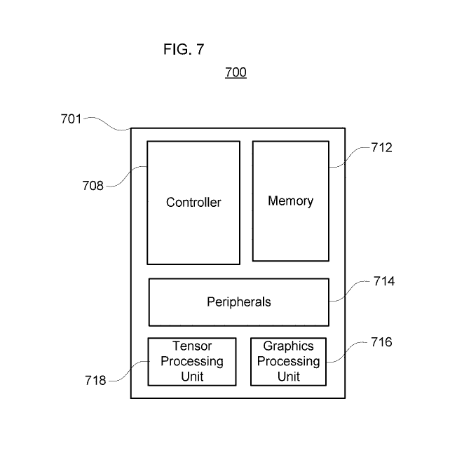

FIG. 7 illustrates further details of an example AP. The AP subsystem 701 as shown in FIG. 7 may include a controller 708 such as a microcontroller or other processor. The controller 708 desirably handles overall operation of the smartphone. This may be done by software or firmware running on the controller 708. Such software/firmware may embody any methods in accordance with the aspects of the present disclosure. In another alternative, aspects of the present disclosure may also be implemented as a combination of firmware and hardware of the application processor subsystem. The software may reside in internal or external memory and any data may be stored in such memory. The hardware may be an application specific integrated circuit (ASIC), field programmable gate array (FPGA), TPU 718, GPU 716, discrete logic components or any combination of such devices. The terms controller and processor are used interchangeably herein. In FIG. 7 the peripherals 714 such as a full or partial keyboard, video or still image display, touch screen or haptic display, audio interface, etc. may be employed and managed through the controller 708.

Cyberbullying over social media may be mitigated by use of the proposed CYBIAN method and apparatus along with involvement of adult supervision whenever a threat is detected.

According to an aspect of the present disclosure, CYBIAN system may use a method similar to the one applied to the receiving device to monitor and detect abusive messages originating from the sender's device with respective Administrator privileges. This aspect may help mitigate bullying from the originating source as opposed or in addition to the receiving end.

According to another aspect of the present disclosure, the CYBIAN system may be configured with a threshold for maximum number of abusive messages for a particular sender category. If the number of abusive messages for a given time period is less than the threshold, the CYBIAN system may not send the messages to the Administrator for that category.

According to a further aspect of the present disclosure, the CYBIAN system may not have an Administrator. In this case the abusive messages may be discarded by the CYBIAN system operating at the recipient device rather than sending to another device.

The consumer electronics devices that may use this disclosure may include, by way of example only, smartphones, tablets, laptops, wearable computing devices, gaming consoles, cameras, video camcorders, televisions, car entertainment systems, etc.

Although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims. Aspects of each embodiment may be employed in the other embodiments described herein.

1. A method for mitigating cyberbullying, the method comprising:
receiving, by one or more processors of a first computing device, an incoming message from a sender at a second computing device;
determining, by the one or more processors, a category of the sender from among a plurality of categories;
classifying, by the one or more processors, the received incoming message based on the category of the sender and an inference model;
generating, by the one or more processors according to the classifying, a metric for the received incoming message; and
either presenting the received incoming message to a user of the first computing device or sending the received incoming message to a third computing device for further consideration as to whether the received incoming message is abusive or non-abusive.

2. The method of claim 1, wherein the plurality of categories includes one or more of (i) trusted senders, (ii) known friends and colleagues, (iii) unknown senders, and (iv) known senders with a history of sending abusive messages.

3. The method of claim 1, wherein the classifying includes machine learning classification of the received incoming message based on the category of the sender and the inference model.

4. The method of claim 3, wherein the machine learning classification employs a classification process selected from the group consisting of Naive Bayes, Support Vector Machine, or Decision Tree.

5. The method of claim 3, wherein the machine learning classification includes:
inputting a training dataset including different types of abusive and non-abusive messages;
categorizing the different types of messages; and
outputting the inference model according to the categorization.

6. The method of claim 5, wherein the inference model reflects one or more patterns in the training dataset identified during the categorizing.

7. The method of claim 1, further comprising:
updating the inference model; and
storing the updated inference model in memory of the first computing device.

8. The method of claim 1, wherein the metric has a normalized range encompassing a for-sure abusive message and a for-sure non-abusive message.

9. The method of claim 1, further comprising evaluating the category of the sender and the metric to determine whether the received incoming message should be presented to the user of the first computing device or sent to the third computing device for further consideration.

10. The method of claim 9, wherein:
evaluating the category of the sender includes determining whether the received incoming message is from a trusted source or another source; and
evaluating the metric includes comparing the metric against a threshold value.

11. The method of claim 10, wherein the threshold value is selected according to the category of the sender.

12. The method of claim 10, wherein the threshold value comprises a plurality of threshold values, and the method further comprises setting each one of the plurality of threshold values according to a corresponding one of the plurality of categories.

13. The method of claim 1, further comprising:
determining whether a maximum number of abusive messages for the category of the sender has been satisfied during a given period of time; and
when the maximum number has not been satisfied during the given period of time, not sending the received incoming message to the third computing device for further consideration.

14. The method of claim 1, further comprising:
determining whether there is an administrator;
when it is determined that there is an administrator, sending the received incoming message to the third computing device for further consideration; and
when it is determined that there is no administrator, discarding the received incoming message instead of sending to the third computing device.

15. A method for mitigating cyberbullying, the method comprising:
receiving, by one or more processors of a third computing device, an incoming message from a first computing device, the incoming message corresponding to a flagged message from a sender at a second computing device;
presenting, by the one or more processors, the received incoming message to an administrator at the third computing device;
receiving, by the one or more processors based on the presenting, an indication whether the flagged message is abusive or non-abusive; and
sending, by the one or more processors, the indication to the first computing device.

16. The method of claim 15, wherein the received incoming message includes a sender category C, a classifier metric M, and message contents of the flagged message.

17. The method of claim 16, wherein the received incoming message further includes meta-information regarding the flagged message.

18. The method of claim 15, wherein when the indication is that the flagged message is abusive, the method further includes taking action to mitigate abusiveness.

19. The method of claim 18, wherein taking action includes blocking selected content associated with either the sender or the flagged message.

20. The method of claim 18, wherein taking action is performed in according with one or more privileges of the administrator.
